(19) United States
(12) Patent Application Publication
(10) Pub. No.: US 2011/0059277 A1
(43) Pub. Date: Mar. 10, 2011

(54) Elastomeric Surface Coatings for Plastic Articles

(76) Inventors: Rainer Kolb, Kingwood, TX (US); William A. Ramsey, Missouri City, TX (US)

(21) Appl. No.: 12/869,161

(22) Filed: Aug. 26, 2010

Related U.S. Application Data
(60) Provisional application No. 61/239,951, filed on Sep. 4, 2009.
(60) Provisional application No. 61/256,124, filed on Oct. 29, 2009.

(51) Int. Cl. B32B 1/00; B32B 27/06; B32B 27/36; B32B 27/32

(52) U.S. Cl. 428/35.7; 428/412; 428/421; 428/422; 428/423.1; 428/424.8; 428/447; 428/476.9; 428/480; 428/507; 428/516; 428/518; 428/521; 428/522; 428/523

(57) ABSTRACT

Coated articles and methods for making the same. The coated article includes a plastic substrate with a coating layer at least partially disposed about the substrate. The coating layer can include at least one propylene copolymer comprising 60 wt % to 98 wt % propylene derived units and 2 wt % to 40 wt % one or more other alpha olefins. The propylene copolymer preferably has a triad tacticity of 90% or more, a heat of fusion of less than 80 J/g, a weight average molecular weight (Mw) as measured by GPC of from 70,000 to 250,000, and a MWD of 2.0 to 2.5.

### CROSS REFERENCE TO RELATED APPLICATIONS

This application claims priority to U.S. Provisional Application Ser. No. 61/239,951 filed Sep. 4, 2009, the disclosure of which is fully incorporated herein by reference. This application is related to U.S. Provisional Application Ser. No. 61/256,124 filed Oct. 29, 2009; U.S. Provisional Application Ser. No. 61/187,431 filed Jun. 16, 2009; U.S. patent application Ser. No. 12/723,291 filed Mar. 12, 2010; U.S. patent application Ser. No. 12/772,811, filed May 3, 2010; and International Patent Application No. PCT/US2010/033429, filed May 3, 2010, the disclosures of which are incorporated by reference in their entireties.

### FIELD OF THE INVENTION

Embodiments of the present invention generally relate to elastomeric surface coatings for plastic articles. More particularly, embodiments of the present invention relate to propylene copolymers for coating thermoplastic articles, such as bottles.

### BACKGROUND OF THE INVENTION

Plastic containers made of polyethylene terephthalate (PET) have become increasingly popular. Containers made of PET are transparent, lightweight, and have the ability to maintain their shape. PET resins are also fairly inexpensive and easy to process as are the containers made therefrom. Containers made of PET, however, are typically not cosmetically or ergonomically attractive.

There exists a need, therefore, for new containers and methods for making the same that are soft, have better feel, and are overall more cosmetically and ergonomically appealing.

### SUMMARY OF THE INVENTION

A coated article and method for making the same are provided. In at least one specific embodiment, the coated article comprises a plastic substrate and a coating layer at least partially disposed about the substrate. The coating layer comprises at least one propylene copolymer comprising 60 wt % to 98 wt % propylene derived units and 2 wt % to 40 wt % one or more other alpha olefins. The propylene copolymer preferably has a triad tacticity of 90% or more, a heat of fusion of less than 80 J/g, a weight average molecular weight (Mw) as measured by GPC of from 70,000 to 250,000, and a MWD of 2.0 to 2.5.

### DETAILED DESCRIPTION

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with available information and technology.

The coated articles are preferably bottles for containing beverages, such as colas, water, juice, sports drinks, beer, wine, and other consumables. Any method or technique suitable for making bottles can be used to form the coated articles, including but not limited to blow molding techniques and stretch blow molding techniques. Preferably, a plastic substrate is made into a preform and then at least partially coated with the coating layer(s) described herein. The coated preforms can then be processed by conventional blow molding techniques to form the coated article. Suitable techniques are described in U.S. Pat. Nos. 7,332,204; 7,261,551; 6,939,591; 6,676,883; 6,391,408; and 6,312,641; and US Publication No. 2008/0061476. In another embodiment, the coating layers(s) can be extruded or co-extruded (if more than one layer) into the shape of a tube, which can then be cut into lengths corresponding to the length of the plastic substrate preform. The resulting cut tube can then be placed inside a mold and injected over the plastic substrate preform to form a coated preform. The coated preform can then be blow-molded to form the coated article. This and other “over-molding” or “inject-over-inject molding” techniques can be used, such as those described in more detail in US Publication No. 2008/0061476 and U.S. Pat. No. 5,464,106.

The coating material or layer provided herein adheres well to plastic substrates, provides even coatings, and is free or at least substantially free of any structural defects. The coating material or layer also retains the surface structure and surface texture of the mold used during the blow molding process, which significantly improves the surface structure and texture of the coated article enabling design options not achievable with the plastic substrate alone. Such design options include embossed or engraved structures that are characterized in having very small spatial resolution of less than 1 mm in one embodiment, less than 500 μm in another embodiment or less than 250 μm in yet another embodiment or less than 100 μm in yet another embodiment. The coating material or layer also exhibits excellent optics, such as low haze, good transparency, and high gloss. Further, the coating material or layer provides excellent tactile properties, such as good grip, soft feel and low surface friction to maintain high bottles speeds. Finally, the coating material or layer maintains the ability to recycle the coated articles.

### Coating Material

Preferably, the coating material or layer is or includes one or more elastomers or elastomeric materials. Suitable elastomers or elastomeric materials can include, but are not limited to, propylene copolymers, ethylene-alpha-olefin random and block copolymers (e.g., Infuse™ elastomers), natural rubber (“NR”), synthetic polyisoprene (“IR”), butyl rubber (copolymer of isobutylene and isoprene, “IIR”), halogenated butyl rubbers (chloro-butyl rubber: “CIIR”; bromo-butyl rubber: “BIIR”), polybutadiene (“BR”), styrene-butadiene rubber (“SBR”), nitrile rubber, hydrogenated nitrile rubbers, chloroprene rubber (“CR”), polychloroprene, neoprene, ethylene-propylene rubber (“EPM”), ethylene-propylene-diene rubber (“EPDM”), epichlorohydrin rubber (“ECO”), polyacrylic rubber (e.g., “ACM”, “ABR”), silicone rubber, fluorosilicone rubber, fluoroelastomers, perfluoroelastomers, polyether block amides (“PEBA”), chlorosulfonated polyethylene (“CSM”), ethylene-vinyl acetate (“EVA”), thermoplastic elastomers (“TPE”), thermoplastic vulcanizates (“TPV”), thermoplastic polyurethane (“TPU”), thermoplastic olefins (“TPO”) (random and block), polysulfide rubber, or blends thereof. Propylene copolymers and blends thereof are preferred. As used herein, the term “propylene copolymer” or simply “PCP” refers to a random copolymer that is elastomeric, has moderate crystallinity, and possesses propylene-derived units and of from 5 to 35 wt % one or more units derived from ethylene, higher α-olefins and/or optionally diene-derived units.

As mentioned above, the overall comonomer content of the propylene copolymer can be of from 5 to 35 wt %. In some embodiments, where more than one comonomer is present in the propylene copolymer, the amount of a particular comonomer may be less than 5 wt %, but the combined comonomer content is preferably greater than 5 wt % and less than 50 wt %. In certain embodiments, the propylene copolymer comprises ethylene or C₄-C₁₀ α-olefin-derived units (or “comonomer-derived units”) within the range of 5 or 7 or 9 to 13 or 16 or 18 wt % by weight of the elastomer. The propylene copolymer may also have two different comonomer-derived units. Also, these copolymers and terpolymers may comprise diene-derived units as described below. In a particular embodiment, the propylene copolymer comprises propylene-derived units and comonomer units selected from ethylene, butene, 1-hexene, and 1-octene. And in a more particular embodiment, the comonomer is ethylene, and thus the propylene copolymer is a propylene-ethylene copolymer. When dienes are present, the propylene copolymer comprises less than 5 or 3 wt %, by weight of the elastomer, of diene derived units, or within the range from 0.1 or 0.5 or 1 to 5 wt % in other embodiments. Suitable dienes include for example: 1,4-hexadiene, 1,6-octadiene, 5-methyl-1,4-hexadiene, 3,7-dimethyl-1,6-octadiene, dicyclopentadiene (“DCPD”), ethylidiene norbornene (“ENB”), norbornadiene, 5-vinyl-2-norbornene (“VNB”), and combinations thereof.

The propylene copolymers may be described by any number of different parameters, and those parameters may comprise a numerical range made up of any desirable upper limit with any desirable lower limit as described herein. For example, the propylene copolymers may have a triad tacticity of three propylene units, as measured by ¹³C NMR, of 75% or greater, 80% or greater, 82% or greater, 85% or greater, or 90% or greater. In one embodiment, the triad tacticity is within the range from 50 to 99%, and from 60 to 99% in another embodiment, and from 75 to 99% in yet another embodiment, and from 80 to 99% in yet another embodiment, and from 60 to 97% in yet another embodiment. Triad tacticity is determined as follows: The tacticity index, expressed herein as “m/r”, is determined by ¹³C nuclear magnetic resonance (“NMR”). The tacticity index m/r is calculated as defined by H. N. Cheng in 17 MACROMOLECULES 1950 (1984), incorporated herein by reference. The designation “m” or “r” describes the stereochemistry of pairs of contiguous propylene groups, “m” referring to meso and “r” to racemic. An m/r ratio of 1.0 generally describes a syndiotactic polymer, and an m/r ratio of 2.0 an atactic material. An isotactic material theoretically may have a ratio approaching infinity, and many by-product atactic polymers have sufficient isotactic content to result in ratios of greater than 50. Embodiments of the propylene copolymer have a tacticity index m/r ranging from a lower limit of 4 or 6 to an upper limit of 8 or 10 or 12.

In certain embodiments, the propylene copolymers may have a heat of fusion (“H_{f}”), determined according to the Differential Scanning Calorimetry (“DSC”) procedure described herein within the range from 0.5 or 1 or 5 J/g, to 35 or 40 or 50 or 65 or 75 or 80 J/g. In certain embodiments, the H_{f} value is less than 80 or 75 or 60 or 50 or 40 J/g. In one or more embodiments, the heat of fusion ranges from a lower limit of 1.0 J/g, or 1.5 J/g, or 3.0 J/g, or 4.0 J/g, or 6.0 J/g, or 7.0 J/g, to an upper limit of 30 J/g, or 35 J/g, or 40 J/g, 45 J/g, or 50 J/g, or 60 J/g or 70 J/g, or 75 J/g, or 80 J/g.

In certain embodiments, the propylene copolymers have a percent crystallinity within the range from 0.5 to 40%, and from 1 to 30% in another embodiment, and from 5 to 25% in yet another embodiment, wherein “percent crystallinity” is determined according to the DSC procedure described herein. The thermal energy for the highest order of polypropylene is estimated at 189 J/g (i.e., 100% crystallinity is equal to 189 J/g). In another embodiment, the propylene copolymer has a crystallinity of less than 40%, and within the range from 0.25 to 25% in another embodiment, and from 0.5 to 22% in yet another embodiment, and from 0.5 to 20% in yet another embodiment.

In certain embodiments, the propylene copolymers may have a single peak melting transition as determined by DSC; in certain embodiments the propylene copolymer has a primary peak melting transition at from less than 90° C., with a broad end-of-melt transition at greater than about 110° C. The peak “melting point” (“Tₘ”) is defined as the temperature of the greatest heat absorption within the range of melting of the sample. However, the propylene copolymer may show secondary melting peaks adjacent to the principal peak, and/or the end-of-melt transition, but for purposes herein, such secondary melting peaks are considered together as a single melting point, with the maximum at the highest Temperature being considered the Tₘ of the propylene copolymer. The propylene copolymers have a peak Tₘ from less than 105 or 100 or 90 or 80 or 70° C. in certain embodiments; and within the range from 10 or 15 or 20 or 25 to 65 or 75 or 80 or 95 or 105° C. in other another embodiments.

The procedure for DSC determinations is as follows. About 0.5 grams of polymer was weighed out and pressed to a thickness of about 15-20 mils (about 381-508 microns) at about 140° C.-150° C., using a “DSC mold” and Mylar™ backing sheet. The pressed pad was allowed to cool to ambient temperature by hanging in air (the Mylar™ backing sheet was not removed). The pressed pad was annealed at room temperature (about 23-25° C.) for about 8 days. At the end of this period, an about 15-20 mg disc was removed from the pressed pad using a punch die and was placed in a 10 microliter aluminum sample pan. The sample was placed in a differential scanning calorimeter (Perkin Elmer Pyris 1 Thermal Analysis System) and was cooled to about −100° C. The sample was heated at about 10° C./min to attain a final temperature of about 165° C. The thermal output, recorded as the area under the melting peak of the sample, is a measure of the heat of fusion and can be expressed in Joules per gram (J/g) of polymer and was automatically calculated by the Perkin Elmer System. Under these conditions, the melting profile shows two maxima, the maxima at the highest temperature was taken as the melting point within the range of melting of the sample relative to a baseline measurement for the increasing heat capacity of the polymer as a function of temperature.

In certain embodiments, the propylene copolymers may have a density within the range from 0.840 to 0.920 g/cm³, and from 0.845 to 0.900 g/cm³ in another embodiment, and from 0.850 to 0.890 g/cm³ in yet another embodiment, the values measured at room temperature per the ASTM D-1505 test method.

In certain embodiments, the propylene copolymers may have a melt flow rate (“MFR”, ASTM D1238, 2.16 kg, 230° C.), from less than 80 or 70 or 50 or 40 or 30 or 24 or 20 dg/min, and within the range from 0.1 or 1 or 4 or 6 to 12 or 16 or 20 or 40 or 60 or 80 dg/min in other embodiments.

In certain embodiments, the propylene copolymers may have a Shore A hardness (ASTM D2240) within the range from 20 or 40 to 80 or 90 Shore A. In yet another embodiment, the propylene copolymers possess an Ultimate Elongation (ASTM D 412) of greater than 500% or 1000% or 2000%; and within the range from 500% to 800 or 1200 or 1800 or 2000 or 3000% in other embodiments.

In certain embodiments, the propylene copolymers may have a weight average molecular weight (“Mw”) value within the range from 50,000 to 1,000,000 g/mole, and from 60,000 to 600,000 in another embodiment, and from 70,000 to 400,000 in yet another embodiment, and from 70,000 to 250,000 in yet another embodiment. The propylene copolymers have a number average molecular weight (“Mn”) value within the range from 10,000 to 500,000 g/mole in certain embodiments, and from 20,000 to 300,000 in yet another embodiment, and from 30,000 to 200,000 in yet another embodiment. The propylene copolymers have a z-average molecular weight (“Mz”) value within the range from 80,000 to 6,000,000 g/mole in certain embodiments, and from 100,000 to 700,000 in another embodiment, and from 120,000 to 500,000 in yet another embodiment.

In certain embodiments, a desirable molecular weight (and hence, a desirable MFR) is achieved by visbreaking the propylene copolymer. The “visbroken propylene copolymer” (also known in the art as “controlled rheology”) is the copolymer that has been treated with a visbreaking agent such that the agent breaks apart the polymer chains. Non-limiting examples of visbreaking agents include peroxides, hydroxylamine esters, and other oxidizing and free-radical generating agents. Stated another way, the visbroken elastomer may be the reaction product of a visbreaking agent and the elastomer. In particular, a visbroken propylene copolymer is one that has been treated with a visbreaking agent such that its MFR is increased, in one embodiment by at least 10%, and at least 20% in another embodiment relative to the MFR value prior to treatment.

In certain embodiments, the propylene copolymers may have a molecular weight distribution (“MWD”) within the range of from a lower range of 1.5 or 1.8 or 2.0 to a higher range of 3.0 or 3.5 or 4.0 or 5.0. Techniques for determining the molecular weight (Mn, Mz and Mw) and MWD are as follows, and as in Verstate et al. in 21 MACROMOLECULES 3360 (1988), incorporated herein by reference. Conditions described herein govern over published test conditions. Molecular weight and MWD are measured using a Waters 150 gel permeation chromatograph equipped with a Chromatix KMX-6 on-line light scattering photometer. The system was used at 135° C. with 1,2,4-trichlorobenzene as the mobile phase. Showdex™ (Showa-Denko America, Inc.) polystyrene gel columns 802, 803, 804, and 805 are used. This technique is discussed in LIQUID CHROMATOGRAPHY OF POLYMERS AND RELATED MATERIALS III 207 (J. Cazes ed., Marcel Dekker, 1981), incorporated herein by reference. No corrections for column spreading were employed; however, data on generally accepted standards, for example, National Bureau of Standards, Polyethylene (SRM 1484) and anionically produced hydrogenated polyisoprenes (an alternating ethylene-propylene copolymer) demonstrate that such corrections on Mw/Mn or Mz/Mw are less than 0.05 units. Mw/Mn was calculated from an elution time-molecular weight relationship whereas Mz/Mw was evaluated using the light scattering photometer. The numerical analyses can be performed using the commercially available computer software GPC2, MOLWT2 available from LDC/Milton Roy-Riviera Beach, Fla.

The propylene copolymers can be produced using any catalyst and/or process known for producing polypropylenes. In certain embodiments, the propylene copolymers can include copolymers prepared according to the procedures in WO 02/36651, U.S. Pat. No. 6,992,158, and/or WO 00/01745. Preferred methods for producing the propylene copolymers are found in US 2004/0236042 and U.S. Pat. No. 6,881,800. Preferred propylene copolymers are available commercially under the trade names Vistamaxx™ (ExxonMobil Chemical Company, Houston, Tex., USA) and Versify™ (The Dow Chemical Company, Midland, Mich., USA), certain grades of Tafmer™ XM or Notio™ (Mitsui Company, Japan) and certain grades of Softel™ (Basell Polyolefins of the Netherlands).

In a preferred embodiment, the coating material or layer comprises from 10 or 20 or 30 or 40 to 50 or 70 or 80 or 90 or 95 or 100%, by weight of the coating, of a propylene copolymer having an MFR of less than 80 or 60 or 40 or 24 or 20 dg/min. In a particular embodiment, the coating layer consists essentially of a propylene copolymer having an MFR of less than 80 or 60 or 40 or 24 or 20 dg/min.

### Plastic Substrate

The plastic substrate can include one or more thermoplastic materials. As used herein, the term “thermoplastic” refers to any material that is not elastic, and that is a polymer or polymer blend considered by persons skilled in the art as being thermoplastic in nature, e.g., a polymer that softens when exposed to heat and returns to its original condition when cooled to room temperature.

In one or more embodiments, the plastic substrate can include one or more polyalkylene naphthalates, polyesters, co-polyesters, polyurethane, polyamids, polyamides, polyolefins, polyolefin homopolymers, polyolefin copolymers, cotton, acrylic, and blends thereof. Preferred polyesters include polyolefin-terephthalates and polyalkylene terephthalates, such as poly(ethylene terephthalate) (PET), poly(butylene terephthalate) (PBT), and poly(cyclohexane dimethylene terephthalate) (PCT). Except as stated otherwise, the term “copolymer” means a polymer derived from two or more monomers (including terpolymers, tetrapolymers, etc.), and the term “polymer” refers to any carbon-containing compound having repeat units from one or more different monomers.

In one or more embodiments, the plastic substrate can include one or more polyolefins, including polyolefin homopolymers and polyolefin copolymers. Except as stated otherwise, the term “copolymer” means a polymer derived from two or more monomers (including terpolymers, tetrapolymers, etc.), and the term “polymer” refers to any carbon-containing compound having repeat units from one or more different monomers. Illustrative polyolefins can be prepared from mono-olefin monomers including, but are not limited to, monomers having 2 to 7 carbon atoms, such as ethylene, propylene, 1-butene, isobutylene, 1-pentene, 1-hexene, 1-octene, 3-methyl-1-pentene, 4-methyl-1-pentene, 5-methyl-1-hexene, mixtures thereof and copolymers thereof with (meth)acrylates and/or vinyl acetates. Preferably, the thermoplastic is unvulcanized or non cross-linked.

In one or more embodiments, the plastic substrate can include polypropylene. The term “polypropylene” as used herein broadly means any polymer that is considered a “polypropylene” by persons skilled in the art (as reflected in at least one patent or publication), and includes homo, impact, and random polymers of propylene. The polypropylene can either derive exclusively from propylene monomers (i.e., having only propylene units) or derive from mainly propylene (more than 80% propylene) with the remainder derived from olefins, particularly ethylene, and/or C₄-C₁₀ α-olefins. Preferred copolymers of propylene include, but are not limited to, terpolymers of propylene, impact copolymers of propylene, random polypropylene and mixtures thereof. Preferred comonomers have 2 carbon atoms, or from 4 to 12 carbon atoms. Preferably, the comonomer is ethylene. Such thermoplastics and methods for making the same are described in U.S. Pat. No. 6,342,565.

Preferably, the polypropylene(s) used in the plastic substrate has a melting point (Tm) above 110° C., includes at least 90 wt % propylene units, and contains isotactic sequences of those units. The polypropylene can also include atactic sequences or syndiotactic sequences, or both. The polypropylene can also include essentially syndiotactic sequences such that the melting point of the polypropylene is above 110° C. Preferably, the plastic substrate contains one or more crystalline propylene homopolymers or copolymers of propylene having a melting temperature greater than 105° C. as measured by DSC.

In one or more embodiments, the polypropylene(s) used in the plastic substrate has a high MFI, such as from a low of 10, or 15, or 20 g/10 min to a high of 25 to 30 g/10 min. Others have a lower MFI, e.g., “fractional” polypropylenes which have an MFI less than 1.0. Those with high MFI can be preferred for ease of processing or compounding.

In one or more embodiments, the polypropylene(s) used in the plastic substrate can be or include one or more random polypropylenes. The term “random polypropylene” as used herein refers to a single phase copolymer of propylene having up to 9 wt %, preferably 2 wt % to 8 wt % of an alpha olefin comonomer. Preferred alpha olefin comonomers have 2 carbon atoms, or from 4 to 12 carbon atoms. Preferably, the alpha olefin comonomer is ethylene.

In a preferred embodiment, the substrate can be poly(ethylene terephthalate) (PET). The PET used in the plastic substrate can have an intrinsic viscosity of from about 0.5 dl/g to about 1.0 dl/g, preferably from about 0.6 dl/g to about 0.85 dl/g and more preferably of from about 0.7 dl/g to about 0.85 dl/g. The PET used in the plastic substrate can be further characterized in having a density of from 1.35 to about 1.47 g/cm3 and a melting point of from about 200 to about 290° C., preferably from about 220 to about 280° C., more preferably from about 230 to about 270° C. Suitable PET grades include Wellman AquaClear™ Ti844, ThermaClear™ Ti818, PermaClear® all commercially available from Wellman Inc, Bay St. Louis, Miss.

In at least one embodiment, the PET substrate can be a three dimensional object including but not limited to a tubular preform. In one embodiment, the preform has a cap threads molded at the open end of the tube. In another embodiment, the PET substrate can be a three dimensional object including but not limited to a beverage container.

### Additives

Any one of the plastic substrate, the coating layer, or both can include one or more additives. Suitable additives can include any one or more processing oils (aromatic, paraffinic and napthathenic mineral oils), compatibilizers, calcined clay, kaolin clay, nanoclay, talc, silicates, carbonates, sulfates, carbon black, sand, glass beads, mineral aggregates, wollastonite, mica, glass fiber, other filler, pigments, colorants, dyes, carbon black, dispersants, flame retardants, antioxidants, conductive particles, UV-inhibitors, stabilizers, light stabilizer, light absorber, coupling agents including silanes and titanates, plasticizers, lubricants, blocking agents, antiblocking agents, antistatic agents, waxes, foaming agents, nucleating agents, slip agents, acid scavengers, lubricants, adjuvants, surfactants, crystallization aids, polymeric additives, defoamers, preservatives, thickeners, rheology modifiers, humectants, vulcanizing/cross-linking/curative agents, vulcanizing/cross-linking/curative accelerators, cure retarders and combinations thereof.

Embodiments of the present invention also include:

A. A coated article, comprising:
a plastic substrate;
a coating layer at least partially disposed about the substrate, the coating layer comprising at least one propylene copolymer comprising 60 wt % to 98 wt % propylene derived units and 2 wt % to 40 wt % one or more other alpha olefins, the propylene copolymer having:
a triad tacticity of 90% or more,
a heat of fusion of less than 80 J/g,
a weight average molecular weight (Mw) as measured by GPC of from 70,000 to 250,000, and

### a MWD of 2.0 to 2.5.

B. The coated article of embodiment A, wherein the propylene copolymer comprises 70 wt % to 95 wt % propylene derived units and 5 wt % to 30 wt % one or more other alpha olefins.
C. The coated article of embodiment A, wherein the propylene copolymer comprises 75 wt % to 95 wt % propylene derived units and 5 wt % to 25 wt % one or more other alpha olefins.
D. The coated article of embodiment A, wherein the propylene copolymer comprises 80 wt % to 90 wt % propylene derived units and 5 wt % to 20 wt % one or more other alpha olefins.
E. The coated article of embodiment A, wherein the propylene copolymer comprises 80 wt % to 90 wt % propylene derived units and 10 wt % to 20 wt % one or more other alpha olefins.
F. The coated article of embodiment A, wherein the propylene copolymer comprises 80 wt % to 88 wt % propylene derived units and 12 wt % to 20 wt % one or more other alpha olefins.
G. The coated article of any preceding embodiment A-F, wherein the alpha olefin is ethylene.
H. The coated article of any preceding embodiment A-F, wherein the alpha olefin is butene.
I. The coated article of any preceding embodiment A-F, wherein the one or more other alpha olefins comprises one or more C₄ to C₁₂ alpha-olefins.
J. The coated article of any preceding embodiment A-I, wherein the propylene derived units are isotactic.
K. The coated article of any preceding embodiment A-J, wherein the weight average molecular weight (Mw) is about 80,000 to about 200,000.
L. The coated article of any preceding embodiment A-J, wherein the weight average molecular weight (Mw) is about 100,000 to about 160,000.
M. The coated article of any preceding embodiment A-J, wherein the weight average molecular weight (Mw) is about 120,000 to about 150,000.
N. The coated article of any preceding embodiment A-M, wherein the MWD is of from 2.1 to 2.4.
O. The coated article of any preceding embodiment A-N, wherein the propylene copolymer comprises of from 10 wt % to 20 wt % units derived from ethylene.
P. The coated article of any preceding embodiment A-O, wherein the propylene copolymer has a MFR (2.16 kg, 230° C.) as measured by ASTM-D1238 of from 3.0 g/10 min to about 21 g/10 min.
Q. The coated article of any preceding embodiment A-P, wherein the coating layer further comprises one or more thermoplastics.
R. The coated article of embodiment Q, wherein the thermoplastics are selected from the group consisting of polypropylene, polyethylene, functionalized polyolefins, plastomers (ethylene-α-olefin copolymers), polyurethane, polyesters such as polyethylene terephthalate, polylactic acid, polyvinyl chloride, polytetrafluoroethylene, styrenic block copolymers, ethylene vinyl acetate copolymers, polyamide, polycarbonate, cellulosics, an elastomer, poly(acetylene), poly(thiophene), poly(aniline), poly(fluorene), poly(pyrrole), poly(3-alkylhiophene), poly(phenylene sulphide), polynaphthalenes, poly(phenylene vinylene), poly(vinylidene fluoride), and blends thereof.
S. The coated article of any preceding embodiment A-R, wherein the coating layer further comprises one or more elastomers selected from the group consisting of natural rubber, synthetic polyisoprene, butyl rubber, halogenated butyl rubbers, polybutadiene, styrene-butadiene rubber, styrenic block copolymers, nitrile rubber, hydrogenated nitrile rubbers, chloroprene rubber, polychloroprene, neoprene, ethylene-propylene rubber and ethylene-propylene-diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, ethylene-α-olefin random and block copolymers, thermoplastic elastomers, thermoplastic vulcanizates, thermoplastic polyurethane, thermoplastic olefins, polysulfide rubber, and blends of any two or more of these elastomers.
T. The coated article of any preceding embodiment A-S, wherein the plastic substrate comprises one or more polyesters selected from the group consisting of polyolefin-terephthalates and polyalkylene terephthalates.
U. The coated article of any preceding embodiment A-S, wherein the plastic substrate comprises poly(ethylene terephthalate) (PET), poly(butylene terephthalate) (PBT), poly(cyclohexane dimethylene terephthalate) (PCT), derivatives thereof, or blends thereof.
V. The coated article of any preceding embodiment A-S, wherein the plastic substrate consists essentially of poly(ethylene terephthalate) (PET).
W. The coated article of any preceding embodiment A-S, wherein the plastic substrate comprises polypropylene, polyethylene, functionalized polyolefins, ethylene-α-olefin copolymer, polyurethane, polyester, polylactic acid, polyvinyl chloride, polytetrafluoroethylene, styrenic block copolymer, ethylene vinyl acetate copolymer, polyamide, polycarbonate, cellulosic, poly(acetylene), poly(thiophene), poly(aniline), poly(fluorene), poly(pyrrole), poly(3-alkylhiophene), poly(phenylene sulphide), polynaphthalenes, poly(phenylene vinylene), poly(vinylidene fluoride), derivatives thereof, or blends thereof.
X. The coated article of any preceding embodiment A-W, wherein the plastic substrate is preformed.
Y. The coated article of any preceding embodiment A-X, wherein the plastic substrate is preformed, at least partially coated with the coating layer, and then blow molded to form the coated article.
Z. The coated article of any preceding embodiment A-Y, wherein the coating layer is 0.1 to 20 mm thick.
AA. The coated article of any preceding embodiment A-Z, wherein the coating layer is 0.1 to 10 mm thick.
BB. The coated article of any preceding embodiment A-AA, wherein the coating layer is 0.1 to 5 mm thick.
CC. The coated article of any preceding embodiment Z-BB, wherein the coating layer thickness varies.
DD. The coated article of embodiment CC, wherein the coating layer thickness varies to form: a pattern, a design, a grip, a graphic, or combinations thereof.
EE. The coated article of any preceding embodiment A-DD, wherein the plastic substrate is a stretch-blow molded article.
FF. The coated article of any preceding embodiment A-EE, wherein the coated article comprises two or more coating layers.
GG. The coated article of embodiment FF, wherein the coated article comprises two or more different coating layers.

### EXAMPLES

The foregoing discussion can be further described with reference to the following non-limiting examples. Tables 1 and 2 summarize polymer blends, according to one or more embodiments described, that were used as the coating layer for a bottle shaped PET container. The PET used was ThermaClear™ Ti818, (Wellman Inc, Bay St. Louis, Miss.) made into a preform, the preform partially coated with the coating layer listed in Tables 1 and 2 and the coated preforms blow molded to form the overcoated bottle shaped PET container.

Table 3 summarizes certain physical properties of plaques compression molded from the coating formulations of Table 1. Table 4 lists the tests procedures used to measure the properties of Table 3. Table 5 shows the bottle appearance evaluation.

TABLE 1
Weight % of polymer compositions.

| | PCP- | PCP- | PCP- | PCP- | PCP- | PCP- | RCP- | RCP- | | | | | |
|---|---|---|---|---|---|---|---|---|---|---|---|---|---|
| EX | 01 | 02 | 03 | 04 | 05 | 06 | 01 | 02 | PP1352 | PP4772 | PP9054 | PP9074 | M1 |
| 1 | 90 | — | — | — | — | — | — | — | — | — | — | 10 | — |
| 2 | — | 90 | — | — | — | — | — | — | — | — | — | 10 | — |
| 3 | 85 | | — | — | — | — | — | — | — | — | — | 10 | 5 |
| 4 | — | 85 | — | — | — | — | — | — | — | — | — | 10 | 5 |
| 5 | — | 80 | — | — | — | — | — | — | — | — | — | 10 | 10 |
| 6 | — | 90 | — | — | — | — | — | — | — | — | — | — | 10 |
| 7 | — | 85 | — | — | — | — | — | — | — | — | — | 5 | 10 |
| 8 | — | 50 | — | 50 | — | — | — | — | — | — | — | — | — |
| 9 | — | — | — | — | — | 100 | — | — | — | — | — | — | — |
| 10 | — | 72 | — | 18 | — | — | — | — | — | — | — | — | 10 |
| 11 | — | 80 | — | 20 | — | — | — | — | — | — | — | 0 | — |
| 12 | — | 45 | — | 45 | — | — | — | — | — | — | — | 10 | — |
| 13 | — | 95 | — | — | — | — | 5 | — | — | — | — | — | — |
| 14 | — | 86 | — | — | — | — | — | 4 | — | — | — | — | 10 |
| 15 | — | 81 | — | — | — | — | 9 | — | — | — | — | — | 10 |
| 16 | — | 90 | — | — | — | — | — | 10 | — | — | — | — | — |
| 17 | — | 80 | — | — | — | — | — | — | — | 10 | — | — | 10 |
| 18 | — | 80 | — | — | — | — | — | — | — | — | 10 | — | 10 |
| 19 | — | 80 | — | — | — | — | — | — | — | — | 10 | — | 10 |
| 20 | — | 80 | — | — | — | — | — | — | — | — | 10 | — | 10 |
| 21 | — | 20 | — | — | — | — | — | — | — | — | 70 | — | 10 |
| 22 | — | 40 | — | — | — | — | — | — | — | — | 50 | — | 10 |
| 23 | — | 10 | — | — | — | — | — | — | — | — | 80 | — | 10 |
| 24 | — | 60 | — | — | — | — | — | — | — | — | 30 | — | 10 |
| 25 | — | — | 20 | — | — | — | — | — | — | — | — | 70 | 10 |
| 26 | — | — | 40 | — | — | — | — | — | — | — | — | 50 | 10 |
| 27 | — | — | 10 | — | — | — | — | — | — | — | — | 80 | 10 |
| 28 | — | — | — | — | — | 80 | — | — | — | — | 10 | — | 10 |
| 29 | — | 40 | — | 40 | — | — | — | — | — | — | 10 | — | 10 |
| 30 | — | 45 | — | 45 | — | — | — | — | — | — | — | — | 10 |
| 31 | — | 80 | — | — | — | — | — | — | 10 | — | — | — | 10 |
| 32 | — | 70 | — | — | — | — | — | — | 20 | — | — | — | 10 |

PCP-01 is a propylene copolymer containing 11 wt % ethylene and has a melting temperature (Tm) of about 64° C.; a heat of fusion of about 30 J/g, and MFR (ASTM-1238D, 2.16 kg, 230° C.) of about 8 g/10 min, and is commercially available from ExxonMobil Chemical Company.

PCP-02 is a propylene copolymer containing 9 wt % ethylene and has a melting temperature (Tm) of about 77° C.; a heat of fusion of about 42 J/g, and MFR (ASTM-1238D, 2.16 kg, 230° C.) of about 8 g/10 min, and is commercially available from ExxonMobil Chemical Company.

PCP-03 is a propylene copolymer containing 16 wt % ethylene and has a melting temperature (Tm) of about 94° C.; a heat of fusion of about 12 J/g, and MFR (ASTM-1238D, 2.16 kg, 230° C.) of about 20 g/10 min, and is commercially available from ExxonMobil Chemical Company.

PCP-04 is a propylene copolymer containing about 7 wt % ethylene and has a MFR (ASTM-1238D, 2.16 kg, 230° C.) of about 7 g/10 min. PCP-04 was prepared as described below and according to the process descriptions summarized in Table 2.

PCP-05 is a propylene copolymer containing about 5 wt % ethylene and has a MFR (ASTM-1238D, 2.16 kg, 230° C.) of about 22 g/10 min. PCP-05 was prepared as described below and according to the process descriptions summarized in Table 2.

PCP-06 is a propylene copolymer containing about 8 wt % ethylene and has a MFR (ASTM-1238D, 2.16 kg, 230° C.) of about 28 g/10 min. PCP-06 was prepared as described below and according to the process descriptions summarized in Table 2.

RCP-01 was obtained from Basell Corporation and is their MOPLEN™ RCP 214 R, which is a random copolymer made from propylene and ethylene. It has a MFR (ASTM-1238D, 2.16 kg, 230° C.) of about 25 g/10 min. and a density of 0.90 g/cm³.

RCP-02 was obtained from Basell Corporation and is their MOPLEN™ RCP 344, which is a random copolymer made from propylene and ethylene. It has a MFR (ASTM-1238D, 2.16 kg, 230° C.) of about 24 g/10 min. and a density of 0.90 g/cm³.

PP1352™ is a random copolymer of propylene with about 1.3 wt % ethylene and is commercially available from ExxonMobil Chemical Company. It has a MFR (ASTM-1238D, 2.16 kg, 230° C.) of about 5.5 g/10 min and a density of 0.90 g/cm³.

PP4772™ is a random copolymer of propylene with about 0.5 wt % ethylene and is commercially available from ExxonMobil Chemical Company. It has a MFR (ASTM-1238D, 2.16 kg, 230° C.) of about 1.6 g/10 min and a density of 0.90 g/cm³.

PP9054™ is a random copolymer of propylene with about 2.2 wt % ethylene and is commercially available from ExxonMobil Chemical Company. It has a MFR (ASTM-1238D, 2.16 kg, 230° C.) of about 12 g/10 min and a density of 0.90 g/cm³.

PP9074™ is a random copolymer of propylene with about 2.8 wt % ethylene and is commercially available from ExxonMobil Chemical Company. It has a MFR (ASTM-1238D, 2.16 kg, 230° C.) of about 24 g/10 min and a density of 0.90 g/cm³.

M1 is a blend of 90% PCP-02 and 10% erucamide. Erucamide comprises (Z)-docos-13-enamide and is a commonly used slip agent.

PCP-04, PCP-05, and PCP-06 were made in a continuous polymerization process using a 28 liter Continuous Flow Stirred Tank Reactor using isohexane as the solvent. The liquid full reactor had a pressure of 1,600 psi (1103 kPa). A mixed feed of hexane, ethylene, and propylene was pre-chilled to approximately 5° C. to 10° C. to remove the heat of polymerization, before entering the reactor. A solution of catalyst/activator in toluene and the scavenger in isohexane were separately and continuously introduced to the reactor to initiate the polymerization. The polymerization catalyst was racemic μ-dimethylsilyl bisindenyl hafnium dimethyl activated at a 1.1 molar ratio with dimethylanilinium tetrakis-heptafluoro, 2-napthylborate.

Temperature control was used to achieve the desired molecular weight. The catalyst system, activated externally to the reactor, was added as needed in amounts effective to achieve the target polymerization temperature. After five residence times of steady polymerization, a representative sample of the polymer produced in this polymerization was collected. The copolymer solution emerging from the reactor was stopped from further polymerization by addition of water and then devolatilized using conventionally known devolatilization methods, such as flashing or liquid phase separation, first by removing the bulk of the isohexane to provide a concentrated solution, and then by stripping the remainder of the solvent in anhydrous conditions using a devolatilizer so as to end up with a molten polymer composition containing less than 0.5 wt % of solvent and other volatiles. The molten polymer was discharged using a single screw extruder connected to a gear pump. The polymer melt was then pelletized in an underwater pelletizer fed with chilled water having a temperature of about 5° C. Table 2 summarizes the polymerization conditions and monomer feed rates.

TABLE 2
Polymerization conditions and monomer feed rates for
making PCP-04, PCP-05, and PCP-06.

| | Target | | Mixed | Cat | | | Ethylene | |
|---|---|---|---|---|---|---|---|---|
| | Poly | | Monomer | Feed | Ethylene | Propylene | Content | MFR |
| | Temp | Poly rate | Feed Temp | Rate | Feed Rate | Feed Rate | (Polymer) | (Polymer) |
| | (° C.) | (kg/hr) | (° C.) | (cc/min) | (kg/hr) | (kg/hr) | wt % | g/10 min |
| PCP-04 | 74.41 | 7.59 | 4.23 | 0.72 | 0.9 | 22.23 | 7 | 6.7 |
| PCP-05 | 84.07 | 9.48 | 2.25 | 2.5 | 0.68 | 24.78 | 4.57 | 22 |
| PCP-06 | 93.01 | 10.86 | −4.4 | 2 | 1.19 | 26.5 | 8.36 | 28 |

TABLE 3
Physical properties of surface coating material.

| | | Vicat | Flexural | Flexural | | Strain | Tensile | | | | | |
|---|---|---|---|---|---|---|---|---|---|---|---|---|
| | | Softening | Modulus, | Modulus, | Stress | at | Strength | | Strain at | Tensile | Tensile | Tensile |
| | Hardness, | Point, | 1% | 2% | at | yield | at Break | Ultimate | break | Modulus | Modulus @ | Modulus @ |
| Example | Shore D | 1000 g | Secant | Secant | yield | (%) | (psi) | elongation % | (%) | @ 100% | 200% | 300% |
| 1 | 32.3 | 49.4 | 8564 | 8369 | 676 | 55.7 | 2325.3 | 1943 | 1917.6 | 672.9 | 681.9 | 717.6 |
| 2 | 40.3 | 65.3 | 19972 | 19234 | 1213 | 25.4 | 2914.1 | 1835 | 1831.4 | 1039.4 | 1043.7 | 1070.6 |
| 3 | 31.2 | 48.5 | 8835 | 8699 | 667 | 44.9 | N/A | 1988 | N/A | 651.4 | 654.4 | 687.2 |
| 4 | 39.5 | 65.8 | 21039 | 20065 | 1214 | 25.2 | 2789.6 | 1784 | 1780.8 | 1036 | 1027 | 1063 |
| 5 | 40.2 | 66.5 | 23184 | 22080 | 1245 | 22.4 | 2798.6 | 1837 | 1790.5 | 1054 | 1054 | 1081 |
| 6 | 35.5 | 60.5 | 15921 | 15228 | 1002 | 28.7 | N/A | 1980 | N/A | 865.6 | 839.7 | 880.4 |
| 7 | 36.8 | 63.5 | 19091 | 18208 | 1153 | 27.7 | 2762 | 1860 | 1820.8 | 983.7 | 972.2 | 1011 |
| 8 | 40.6 | 69.5 | 23702 | 22457 | 1283 | 25.3 | 2870.6 | 1860 | 1857 | 1043.3 | 1039 | 1059.8 |
| 9 | 43.5 | 76.2 | 32296 | 30167 | 1562 | 20.6 | 3088 | 1772 | 1768.5 | 1156.8 | 1172.6 | 1224 |
| 10 | 38 | 66.1 | 20115 | 19127 | 1201 | 26.6 | 2854.7 | 1854 | 1851.1 | 1013.6 | 982.9 | 1019.5 |
| 11 | 40.3 | 68.3 | 20943 | 19921 | 1253 | 26 | 2785.3 | 1863 | 1774 | 1030.1 | 1007 | 1037.3 |
| 12 | 39 | 67.8 | 22659 | 21436 | 1243 | 25.2 | 3020 | 1952 | 1933.4 | 1016.4 | 1024.8 | 1051.5 |
| 13 | 35 | 62.6 | 16490 | 15997 | 1063 | 28.1 | 2773.5 | 1907 | 1883.5 | 915.5 | 902.9 | 936.1 |
| 14 | 35.3 | 62 | 17474 | 16766 | 1033 | 28.7 | 2800 | 193 | 1882 | 895.8 | 892.5 | 926.5 |
| 15 | 37 | 63.6 | 19190 | 18391 | 1133 | 25.7 | 1594.8 | 1720 | 1716.5 | 974.2 | 977.7 | 1016.2 |
| 16 | 36.5 | 63.8 | 19051 | 18303 | 1091 | 27.5 | 2775.3 | 1908 | 1839.6 | 940.8 | 942.5 | 980.8 |

TABLE 4
Test procedures

| Property | Method |
|---|---|
| Hardness, 15 sec | ASTM D2240 |
| Vicat Softening Point, 1000 g | ASTM D1525 |
| Flexural Modulus, 1% Secant | ASTM D790 |
| Tensile Strength at Break | ASTM D638-99 |
| Ultimate Elongation | ASTM D638-99 |
| Tensile Modulus @ 100% | ASTM D638-99 |
| Tensile Modulus @ 300% | ASTM D638-99 |

TABLE 5
Bottle appearance evaluation.

| | Optical surface | Optical | Tactile | Tactile | | Elasticity of |
|---|---|---|---|---|---|---|
| | Appearance | surface | appearance | appearance of the | Delamination | surface coating |
| | rating of the | Appearance | rating of the | bottle coating | from the PET | over PET |
| EX. | bottle coating | (observation) | bottle coating | (observation) | bottle | bottle |
| 1 | Acceptable | clear | Not acceptable | too tacky | no | Acceptable |
| 2 | Acceptable | glossy, clear | Not acceptable | too tacky | no | Acceptable |
| 3 | Acceptable | glossy, clear | Acceptable | soft feel, low tack | no | Acceptable |
| 4 | Acceptable | glossy, clear | Acceptable | soft feel, low tack | no | Acceptable |
| 5 | Acceptable | glossy, clear | Acceptable | soft feel, low tack | no | Acceptable |
| 6 | Acceptable | glossy, clear | Not acceptable | too tacky | no | Acceptable |
| 7 | Acceptable | glossy, clear | Acceptable | soft feel, low tack | no | Acceptable |
| 8 | Acceptable | glossy, clear | Not acceptable | too tacky, too soft | no | Acceptable |
| 9 | Acceptable | glossy, clear | Not acceptable | too tacky, too soft | no | Acceptable |
| 10 | Acceptable | glossy, clear | Acceptable | soft feel, low tack | no | Acceptable |
| 11 | Acceptable | glossy, clear | Acceptable | low tack | no | Acceptable |
| 12 | Acceptable | glossy, clear | Acceptable | soft feel, low tack | no | Acceptable |
| 13 | Acceptable | glossy, clear | Acceptable | soft feel, low tack | no | Acceptable |
| 14 | Acceptable | glossy, clear | Acceptable | soft feel, low tack | no | Acceptable |
| 15 | Acceptable | glossy, clear | Acceptable | soft feel, low tack | no | Acceptable |
| 16 | Acceptable | glossy, clear | Acceptable | soft feel, low tack | no | Acceptable |
| 17 | Not acceptable | hazy | Acceptable | low tack | yes | Not acceptable |
| 18 | Acceptable | clear | Acceptable | low tack | no | Acceptable |
| 19 | Acceptable | clear | Acceptable | low tack | no | Acceptable |
| 20 | Acceptable | clear | Acceptable | low tack | no | Acceptable |
| 21 | Acceptable | clear | Not acceptable | low tack, hard feel | no | Acceptable |
| 22 | Acceptable | clear | Not acceptable | low tack, hard feel | no | Acceptable |
| 23 | Acceptable | clear | Not acceptable | low tack, hard feel | no | Acceptable |
| 24 | Acceptable | clear | Not acceptable | low tack, hard feel | no | Acceptable |
| 25 | Acceptable | clear | Not acceptable | low tack, hard feel | yes | Acceptable |
| 26 | Not acceptable | hazy | Not acceptable | low tack, hard feel | yes | Acceptable |
| 27 | Acceptable | clear | Not acceptable | low tack, hard feel | no | Not acceptable |
| 28 | Not acceptable | hazy | Not acceptable | low tack, hard feel | yes | Not acceptable |
| 29 | Acceptable | clear | Not acceptable | low tack, hard feel | yes | Not acceptable |
| 30 | Acceptable | clear | Not acceptable | low tack, hard feel | yes | Not acceptable |
| 31 | Not acceptable | hazy | Acceptable | low tack | yes | Not acceptable |
| 32 | Not acceptable | Hazy | Not acceptable | low tack, hard feel | yes | Not acceptable |

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A coated article, comprising:
a plastic substrate;
a coating layer at least partially disposed about the substrate, the coating layer comprising at least one propylene copolymer comprising 60 wt % to 98 wt % propylene derived units and 2 wt % to 40 wt % one or more other alpha olefins, the propylene copolymer having:
a triad tacticity of 90% or more,
a heat of fusion of less than 80 J/g,
a weight average molecular weight (Mw) as measured by GPC of from 70,000 to 250,000, and
a MWD of 2.0 to 2.5.

2. The coated article of claim 1, wherein the propylene copolymer comprises 70 wt % to 95 wt % propylene derived units and 5 wt % to 30 wt % one or more other alpha olefins.

3. The coated article of claim 1, wherein the propylene copolymer comprises 75 wt % to 95 wt % propylene derived units and 5 wt % to 25 wt % one or more other alpha olefins.

4. The coated article of claim 1, wherein the propylene copolymer comprises 80 wt % to 90 wt % propylene derived units and 5 wt % to 20 wt % one or more other alpha olefins.

5. The coated article of claim 1, wherein the propylene copolymer comprises 80 wt % to 90 wt % propylene derived units and 10 wt % to 20 wt % one or more other alpha olefins.

6. The coated article of claim 1, wherein the propylene copolymer comprises 80 wt % to 88 wt % propylene derived units and 12 wt % to 20 wt % one or more other alpha olefins.

7. The coated article of claim 1, wherein the alpha olefin is ethylene.

8. The coated article of claim 1, wherein the alpha olefin is butene.

9. The coated article of claim 1, wherein the one or more other alpha olefins comprises one or more C₄ to C₁₂ alpha-olefins.

10. The coated article of claim 1, wherein the propylene derived units are isotactic.

11. The coated article of claim 1, wherein the weight average molecular weight (Mw) is about 80,000 to about 200,000.

12. The coated article of claim 1, wherein the weight average molecular weight (Mw) is about 100,000 to about 160,000.

13. The coated article of claim 1, wherein the weight average molecular weight (Mw) is about 120,000 to about 150,000.

14. The coated article of claim 1, wherein the MWD is of from 2.1 to 2.4.

15. The coated article of claim 1, wherein the propylene copolymer comprises of from 10 wt % to 20 wt % units derived from ethylene.

16. The coated article of claim 1, wherein the propylene copolymer has a MFR (2.16 kg, 230° C.) as measured by ASTM-D1238 of from 3.0 g/10 min to about 21 g/10 min.

17. The coated article of claim 1, wherein the coating layer further comprises one or more thermoplastics.

18. The coated article of claim 17, wherein the thermoplastics are selected from the group consisting of polypropylene, polyethylene, functionalized polyolefins, plastomers (ethylene-α-olefin copolymers), polyurethane, polyesters such as polyethylene terephthalate, polylactic acid, polyvinyl chloride, polytetrafluoroethylene, styrenic block copolymers, ethylene vinyl acetate copolymers, polyamide, polycarbonate, cellulosics, an elastomer, poly(acetylene), poly(thiophene), poly(aniline), poly(fluorene), poly(pyrrole), poly(3-alkylhiophene), poly(phenylene sulphide), polynaphthalenes, poly(phenylene vinylene), poly(vinylidene fluoride), and blends thereof.

19. The coated article of claim 1, wherein the coating layer further comprises one or more elastomers selected from the group consisting of natural rubber, synthetic polyisoprene, butyl rubber, halogenated butyl rubbers, polybutadiene, styrene-butadiene rubber, styrenic block copolymers, nitrile rubber, hydrogenated nitrile rubbers, chloroprene rubber, polychloroprene, neoprene, ethylene-propylene rubber and ethylene-propylene-diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, ethylene-α-olefin random and block copolymers, thermoplastic elastomers, thermoplastic vulcanizates, thermoplastic polyurethane, thermoplastic olefins, polysulfide rubber, and blends of any two or more of these elastomers.

20. The coated article of claim 1, wherein the plastic substrate comprises one or more polyesters selected from the group consisting of polyolefin-terephthalates and polyalkylene terephthalates.

21. The coated article of claim 1, wherein the plastic substrate comprises poly(ethylene terephthalate) (PET), poly(butylene terephthalate) (PBT), poly(cyclohexane dimethylene terephthalate) (PCT), derivatives thereof, or blends thereof.

22. The coated article of claim 1, wherein the plastic substrate consists essentially of poly(ethylene terephthalate) (PET).

23. The coated article of claim 1, wherein the plastic substrate comprises polypropylene, polyethylene, functionalized polyolefins, ethylene-α-olefin copolymer, polyurethane, polyester, polylactic acid, polyvinyl chloride, polytetrafluoroethylene, styrenic block copolymer, ethylene vinyl acetate copolymer, polyamide, polycarbonate, cellulosic, poly(acetylene), poly(thiophene), poly(aniline), poly(fluorene), poly(pyrrole), poly(3-alkylhiophene), poly(phenylene sulphide), polynaphthalenes, poly(phenylene vinylene), poly(vinylidene fluoride), derivatives thereof, or blends thereof.

24. The coated article of claim 1, wherein the plastic substrate is preformed.

25. The coated article of claim 1, wherein the plastic substrate is preformed, at least partially coated with the coating layer, and then blow molded to form the coated article.
